(19) United States
(12) Patent Application Publication
(10) Pub. No.: US 2021/0080924 A1
(43) Pub. Date: Mar. 18, 2021

(54) Diagnosis Method and Diagnosis System for a Processing Engineering Plant and Training Method

(71) Applicant: Siemens Aktiengesellschaft, Muenchen (DE)

(72) Inventors: Daniel LABISCH, Karlsruhe (DE); Thomas BIERWEILER, Karlsruhe (DE); Nils ZUFALL, Neuwied (DE)

(21) Appl. No.: 17/023,504

(22) Filed: Sep. 17, 2020

(30) Foreign Application Priority Data
Sep. 18, 2019 (EP) 19198052

(51) Int. Cl. G05B 19/406; G06N 20/00

(52) U.S. Cl. CPC G05B 19/406; G05B 2219/32369; G06N 20/00

(57) ABSTRACT

A diagnosis method, a diagnosis system, a process-engineering plant and a training method for the diagnosis system, wherein course over time of plant data, which at least partially characterizes the plant status, is provided and a plant status is classified with the aid of a plurality of models based on the course over time of the plant data, where each model of the plurality of models differs with respect to a time window from which the plant data are based, a confidence is allocated to each classification that result from the at least two models, and where diagnosis information based on the classifications of the plant status and the confidences allocated thereto is output.

### BACKGROUND OF THE INVENTION

### 1. Field of the Invention

The present invention relates to a diagnosis method, a diagnosis system for a process-engineering plant and to a training method for the diagnosis system.

### 2. Description of the Related Art

Process-engineering plant, such as refineries or factories, in which, for example, substances are changed with respect to composition, type or property, can have extremely complex structures. A plant be composed, for example, from a large number of components, optionally linked together and/or independent of each other, for instance valves, sensors, actuators and/or the like. Such plants are, as a rule, managed by specific, particularly computer-based or at least computer-aided, process control systems, which can consider, in particular, the process-engineering correlations between the different components. Such process control systems comprise automation engineering, in particular automation programs and operating and observation programs.

A process control system can conventionally specify the majority of boundary conditions under which the process should take place, such as by manipulated variables or parameter values. In addition, there are also boundary conditions, however, which cannot be influenced by the process control system, and are possibly even unknown. Against the background of this highly complex structure, it can therefore be difficult or at least very complex to reliably predict the actual operating state of the plant.

To counteract this, it is basically known to classify the current plant status. Normal operation or one of various malfunctions, in other words, a deviation from normal operation, can be allocated to the plant, therefore. If a malfunction is present, an attempt can be made to transfer the plant back into normal operation. That the identification of a malfunction potentially comes too late to prevent losses in quality or even production outages can be a problem here.

### SUMMARY OF THE INVENTION

It is therefore an object of the present invention to improve the diagnosis of a process-engineering plant, in particular to quickly identify the development through to a malfunction, in a minimum amount of time.

This and other objects and advantages are achieved in accordance with the invention by a diagnosis method and a diagnosis system for a process-engineering plant and a training method for the diagnosis system, wherein the diagnosis method for the process-engineering plant includes the steps of (i) providing a course over time of plant data, which at least partially characterizes the plant status, classifying a plant status with the aid of at least two models based the course over time of the plant data, where the models differ in respect of a time window, from which the plant data are based, (iii) allocating a confidence to each of the classifications that result from the at least two models, and (iv) outputting diagnosis information that is based on the classifications of the plant status and the confidences allocated thereto.

Plant data within the meaning of the invention is, in particular, measured variables and/or manipulated variables. Measured variables, such as temperature or pressure in the plant or a plant component, can be detected, for instance, by appropriate sensors. Manipulated variables, such as a valve setting or a motor power, can be specified, for example, by a process control system or a plant user.

A course over time of plant data within the meaning of the invention is, in particular, a sequence over time of the plant data or the development of the plant data over a specified period. A course over time of plant data can be provided, for example, as a data volume, which the plant data contains over the specified period or a time interval. Such a data volume can contain, for example, all detected or specified measured and/or manipulated variables over 10 seconds.

A confidence within the meaning of the invention is, in particular, a measure of the trust that a classification is met with. A confidence can be, for example, a probability, in particular a statistically determined probability, with which a classification applies. A confidence can indicate, in particular, how reliable the model is according to which the classification was performed.

In accordance with the invention, at least two models are used for classification of a plant status of a process-engineering plant and classifications are allocated a confidence, which indicates, for example, a reliability of the classification. The models differ at least in that they process plant data, which at least partially characterizes the plant status, from different time windows as input variables. The time windows preferably illuminate different time segments from a provided course over time of the plant data. Due to the different time windows, different emphases can be set or are set accordingly in the diagnosis of the plant in respect of the plant status, wherein, for each emphasis, the reliability of the diagnosis can be provided by way of the allocated confidence. It is possible and optionally even advantageous that the time windows at least partially overlap. For example, different system dynamics having different, overlapping time windows can be detected. Therefore, a far-reaching, and, owing to the choice of different time windows, flexible and particularly detailed diagnosis of the plant is possible.

The course over time of the plant data can be temporarily stored for evaluation, in particular during operation of the plant, such as in a storage device. Therefore, the plant data can be understood as historic plant data, by the evaluation of which, with the aid of the at least two models, information can be obtained with respect to the current plant status.

The course over time of plant data can be evaluated in a forward-looking manner, in other words, from a defined starting instant, preferably with discontinuous production methods, such as batch processes. The starting instant can lie in the past in this connection. From the starting instant, which preferably corresponds to the beginning of the process, plant data from time windows of different length and/or different temporal resolution can form the basis of the at least two models for, in particular successive, classification of the plant status.

Alternatively, the course over time of plant data can be evaluated retrospectively, i.e., up to a defined end instant, preferably with continuous production methods. The end instant preferably corresponds here to the present. The time windows preferably all extend up to the end instant.

When evaluating the plant data from the course of time within the time window, the at least two models preferably use all available, but at least some of the measured and manipulated variables, which were or are recorded within the corresponding time window. In other words, the models used here are adapted to process time series defined by the time windows. Herein, the models used here differ from pure modelings of the plant or the ongoing processes, which predict the plant status. Such modelings are conventionally based on a set of parameters as input variables, in other words, for example, all manipulated and measured variables at a fixed instant (for instance the present). A classification with the aid of such a modeling can only follow due to a separate or independent, static classification method, however, which is applied to the predicted plant status. In contrast to this, in the present case the classification can occur via the models themselves. This also allows the reliable allocation of a confidence.

In a preferred embodiment, the time windows differ with respect to their length of time. Consequently, in particular with forward-looking evaluation of the course over time of plant data, a first classification can already be present at an early stage while further, possibly more precise or more reliable classifications can be made available only thereafter. However, even in the case of retrospective evaluation of the course over time of plant data, such as owing to computing time advantages, the classification can be present earlier based on plant data from a shorter time window. In the case of a malfunction, this enables a response at an early stage already, with appropriate protective countermeasures or also those designated “therapy”.

The time windows preferably all extend from the starting instant, in particular from the beginning of the provided course over time. Alternatively, the time windows can also all extend up until the end instant, in particular until the end of the provided course over time. For the time ranges at the beginning or end of the provided course over time, a strong overlap timewise can result accordingly. The, in particular successive, evaluation of the plant data from the time windows allows early classification and can at the same time, with increasing length of the time window, be based on increasingly better available information, and increased confidence in relation to the correct classification due to correspondingly longer time series can be achieved, therefore.

In a further preferred embodiment, the lengths of time of the time windows are logarithmically distributed. In other words, the time windows have lengths of time, which depend on a logarithmic function or are defined by a logarithmic function. This can be preferred in particular if the plant status is classified based on plant data from time windows with significantly different lengths of time, i.e., on the one hand, very short time windows and, on the other hand, very long time windows are considered. The logarithmic distribution of the time windows makes it possible to reduce the number of models used, such that computing time can be reduced. This is particularly advantageous in view of a real-time application of the diagnosis method.

In a further preferred embodiment, the time windows differ with respect to their metrics. For example, different time windows can define time series in which the plant data in each case has different time intervals. In other words, for example, the temporal resolution can be different in different time windows. Consequently, it is possible to effectively analyze different system dynamics particularly effectively and to reliably classify the plant status accordingly. In addition, the computing capacity required for classification or for processing the corresponding time series can optionally be reduced by way of different metrics.

In a further preferred embodiment, at least one of the time windows has logarithmic metrics. In particular, the time series defined by the time window can run logarithmically, i.e., the time intervals between the plant data can increase logarithmically over the course of the time series. Therefore, for example, with forward-looking evaluation of the plant data at the beginning or with retrospective evaluation of the plant data toward the end, a closer evaluation or analysis of the plant data can be made. Consequently, fast dynamics can also be considered in long time series, in particular without significantly increasing the required computing capacity.

In a further preferred embodiment, temporally logarithmically spaced-apart plant data is provided as the course over time. In particular, the time intervals between the plant data within the provided course over time can logarithmically increase or decrease. This makes fast processing of the plant data possible even in the case of extended time windows, in particular those without logarithmic metrics.

In a further preferred embodiment, an input signal relating to the plant status is detected and forms the basis of an adjustment of the confidences. The input signal is preferably a user input, for example, of a plant user. Alternatively, the input signal can also be an output signal of a different monitoring system, however. The input signal preferably represents a correct or true classification of the plant status. For adjustment of the confidences, the input signal can be compared, for example, with at least one of the classifications. If the input signal matches the classification, the corresponding confidence can be increased. If the input signal does not match the classification, on the other hand, then the corresponding confidence can be reduced. This allows a continuous increase in the trust in the diagnosis system.

In a further preferred embodiment, an input signal relating to the plant status is detected and forms the basis of an adjustment of at least one of the at least two models. The input signal is preferably a user input, for example, of a plant user. Alternatively, the input signal can also be an output signal of a different monitoring system, however. The input signal preferably represents a correct or true classification of the plant status. For adjustment of the models, the input signal can be compared, for example, with at least one of the classifications. If the classification represented by the input signal does not match the classification by the corresponding model or deviates at least significantly therefrom, the model can be adjusted. This allows for a continuous increase in the reliability of the diagnosis system.

In a further preferred embodiment, a status analysis of the engineering plant is performed based on at least one classification. The status analysis can be performed by a plant user or a different monitoring system and, in particular, can comprise a classification of the plant status. In the course of the status analysis, the plant user can make a user input, or the other monitoring system generate an output signal, which represents the correct or true classification of the plant status.

The classification, on the basis of which the status analysis is performed, can correspond in particular with an, until now, unknown malfunction of the plant, in other words, one which has not occurred in the past. Preferably, at least one of the models and/or confidences is adjusted, in particular expanded, in this case. Consequently, the diagnosis of the plant can be continuously improved.

In a further preferred embodiment, the diagnosis information comprises an overall classification of the plant status, where the overall classification is determined based on the classifications, which result from the at least two models, and the confidences allocated thereto. In particular, the overall classification can match the currently available classification, which was determined based on the plant data from the longest time window. Alternatively, the overall classification can also match the currently available classification, however, to which the highest confidence is allocated. In a further alternative, the overall classification can also be determined from a statistical evaluation of a plurality of classifications and the confidences allocated to them. Due to its unambiguousness, the function of an overall classification can increase user convenience or facilitate control of the plant.

In a further preferred embodiment, the overall classification is determined as a function of a sequence of classifications. Preferably, a sequence is predefined in this case, in which the resulting classifications are evaluated to determine the overall classification. For example, the classifications can be ordered according to the increasing length of the time window, from which plant data forms the basis of the corresponding model, from which the sequence of classifications results.

In one example, a first short time series is classified as pertaining to normal operation N, while a second and third longer time series can be classified as pertaining to a malfunction F, respectively. An overall classification, such as malfunction F, is preferably allocated to the resulting sequence NFF. A different overall classification, such as normal operation N, can be allocated to a different resulting sequence for instance NFN or NNF. Determination of the overall classification as a function of the sequence of classifications, in particular based on a predefined allocation of different sequences to at least one category, has the advantage of being able to allocate conditional confidences determined, for example in the course of a training method, to the overall classification. Such conditional confidences can indicate, for example, a combination of probabilities, in particular conditional probabilities, with which the individual classifications from the sequence depict the correct or true classification. The overall classification determined in this way can therefore be particularly reliable.

It is also an object of the invention to provide a diagnosis system for a process-engineering plant, which is configured to perform the diagnosis method in accordance with disclosed embodiments of the invention, and which includes a storage device in which the at least two models and the confidences to be allocated to the classifications are stored for use in the disclosed embodiments of the method. A diagnosis system of this kind enables monitoring of a process-engineering plant, in particular a control system of the process-engineering plant, in particular in real time.

It is also an object of the invention to provide a training method for a diagnosis system in accordance with the invention, where the at least two models are determined by machine learning. Preferably, the plant data of a first quantity of a plurality of courses over time from at least two different time windows and information with respect to the plant statuses corresponding with the plurality of courses over time forms the basis of machine learning. The plant data of the first quantity of a plurality of courses over time is preferably historical plant data and corresponds with different plant statuses, in particular normal operation and defined deviations. For example, correct or true classifications of these plant statuses can form the basis of machine learning. With the aid of machine learning, for example, patterns in the time series of courses over time defined by the different time windows, which all correspond with the same plant status, can be found, therefore, and be used for modelling.

In a preferred embodiment, the confidences are determined based on a statistical evaluation of the classifications, which result from the at least two models for plant data from a second quantity of a plurality of courses over time. For example, for each of the models, the number of classifications resulting from the application of the appropriate model can be detected and compared with the number of cases in which the classification by the model matches the underlying correct or true classification, in particular are related to each other. In other words, a data set, for instance, in the form of a histogram, can be generated from which for each of the models, the number of correct classifications and/or the number of incorrect classifications emerges. When processing plant data from further courses over time of the second quantity, but in particular also when processing plant data from the course over time during real operation of the plant, in other words, when performing the diagnosis method in accordance with the disclosed embodiments of the invention, the data set can be updated accordingly, i.e., the occurrence of incorrect or correct classifications incremented. Processing of an increasing volume of data makes it possible to improve the reliability of the determined confidence, therefore.

It is also possible in this connection that sequences of classifications resulting from the at least two models are stored in the data set and the occurrence of these sequences is counted. This can make it possible, in particular, to determine conditional confidences, which allow a particularly reliable assessment of the correctness of a classification.

In a further preferred embodiment, a selection of the models is stored in the storage device based on the classifications, which result from the at least two models for plant data from a second quantity of a plurality of courses over time. If, for example, two models classify plant data from a plurality of courses of time substantially the same independently of whether the plant data originates from different time windows in each case, then one of the models can possibly be dispensed with. The selection can be based on a statistical limit, according to which at least two different models have to classify a specified percentage of different courses over time as substantially the same, such that one of the models is selected, stored and therewith applied, for example, in the disclosed embodiment of the diagnosis method in accordance with the invention. Storage and therewith optionally subsequent use of a limited selection of the models learned first of all can be advantageous in view of the required computing power.

The description of preferred embodiments of the invention given up until now contains numerous features, which are reproduced in the individual dependent claims, several of them being combined in some cases. These features can also be considered individually, however, and be combined to form expedient further combinations. In particular, these features can in each case be combined individually and in any suitable combination with the diagnosis method in accordance with the disclosed embodiments of the invention, the diagnosis system in accordance with the disclosed embodiments of the invention and the training method in accordance with the disclosed embodiments of the invention.

The properties, features and advantages of the invention described above and the manner in which these are achieved will become clearer and more comprehensible in connection with the following description of exemplary embodiments of the invention, which are explained in more detail in connection with the figures in which the same reference characters are consistently used for the same or mutually corresponding elements of the invention. The exemplary embodiments serve to explain the invention and do not limit the invention to the combinations of features disclosed therein, nor in respect of functional features. In addition, features of the exemplary embodiments suitable for this can also be considered expressly in isolation and be combined with any of the claims.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which these are achieved will now become clearer and more intelligible in conjunction with the following description of the exemplary embodiment, which will be explained in detail making reference to the drawings, in which:

FIG. 1 shows an exemplary graphical plot of a course over time of plant data, which is divided into time windows in accordance with the invention;

FIG. 2 shows an exemplary flow chart of a diagnosis method in accordance with the invention;

FIG. 3 shows an exemplary schematic block diagram of a diagnosis system in accordance with the invention; and

FIG. 4 shows an exemplary diagram illustrating a training method in accordance with the invention.

### DETAILED DESCRIPTION OF THE EXEMPLARY EMBODIMENTS

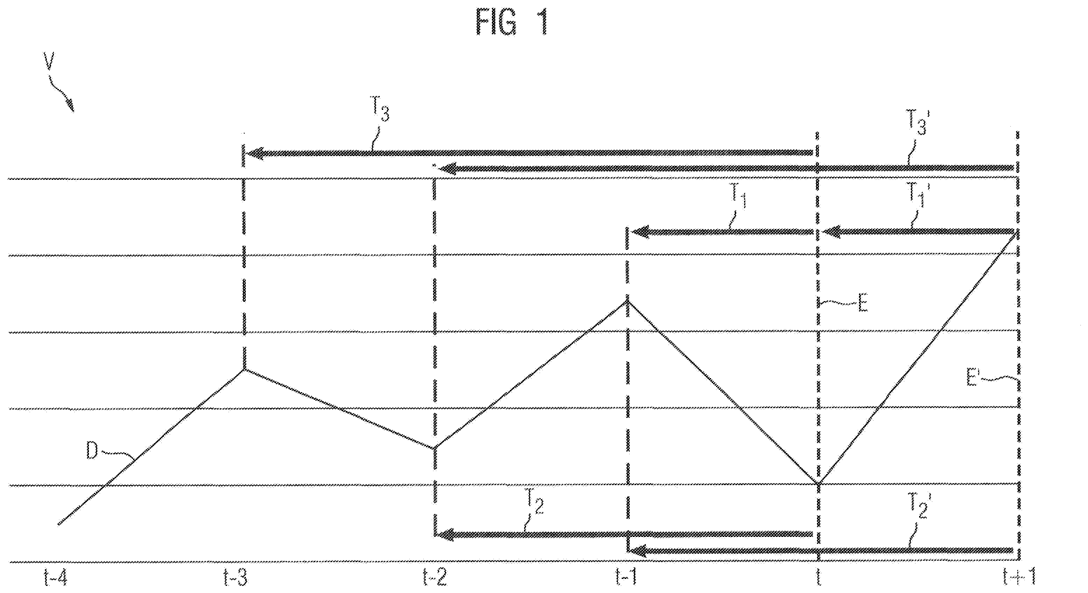

FIG. 1 shows an exemplary graphical plot of a course over time V of plant data D, which is divided into time windows T₁, T₂, T₃ of different length. The plant data D preferably corresponds at least to one measured and/or manipulated variable of a process-engineering plant, which is plotted over time. The plant data D characterizes a status of the plant, such as normal operation or one of possibly several malfunctions. The course over time V of the plant data D can be characteristic of the plant status in which the plant is, for example, at instant t. In particular, the course V can characterize a dynamic, on the basis of which the plant changes from one plant status to another one or else remains in the same status.

The course over time V of the plant data D can be used accordingly to implement a classification of the plant status with the aid of models. Preferably, in each case one of the time windows T₁, T₂, T₃ is allocated to the models, i.e., the plant data D within the respectively allocated time window T₁, T₂, T₃ is processed by the models. The time windows T₁, T₂, T₃ differ in the illustrated example with respect to their length of time. The first time window T₁ has, for example, a length 1, the second time window T₂ a length 2 and the third time window T₃ a length 3. Consequently, the models can possibly be sensitive to different dynamics in the course of time V. As an alternative or in addition, the time windows T₁, T₂, T₃ can also differ with respect to their metrics, however.

In continuous operation of the plant, the time windows T₁, T₂, T₃ are preferably selected such that they all reach up to an end instant E. The end instant E corresponds in this connection preferably with the present t, in other words, lie at the end instant E, in particular currently up-to-date plant data D.

If the plant continues to operate, the end instant E corresponding with the present shifts further accordingly as do the time windows T₁, T₂, T₃ as well, therefore. At the instant t+1 the shifted time windows T₁′, T₂′, T₃′ extend up to the shifted end instant E′, therefore. Consequently, it is possible to ensure that the diagnosis of the plant, in particular the classification of the current plant status, is always based on current plant data D.

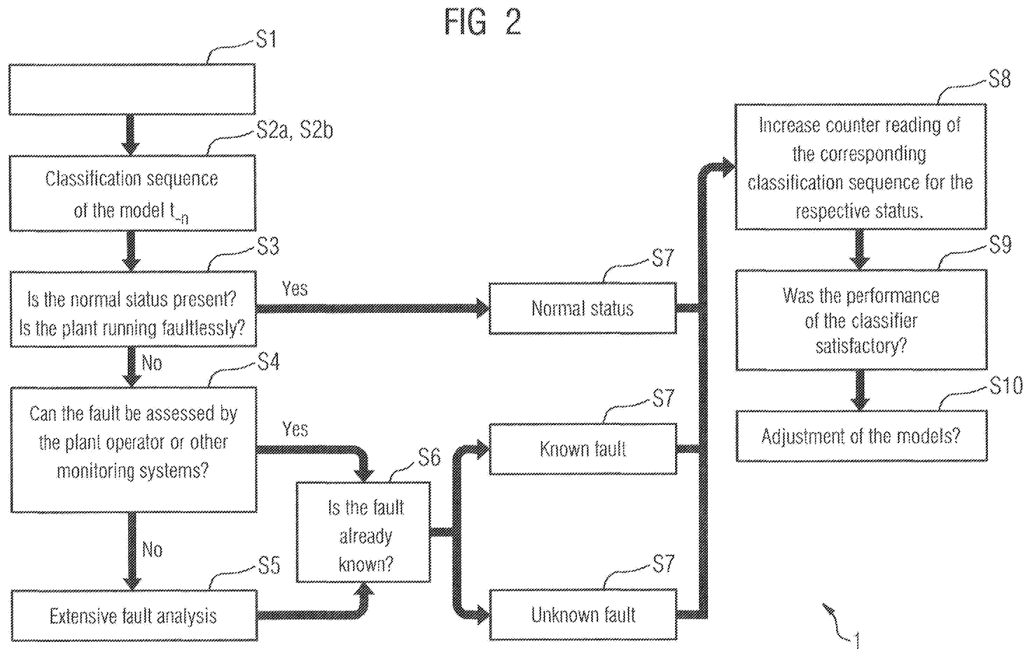

FIG. 2 shows an exemplary flowchart of the diagnosis method 1 for a process-engineering plant in accordance with the invention. In a method step S1, a course over time of plant data, which at least partially characterizes the plant status, is provided (see FIG. 1). In a further method step S2a, the plant data of the plant status is classified with the aid of at least two models based on the course over time. The models are preferably applied to time series, which are defined by differing time windows and in each case contain an extract of the provided course over time of the plant data. In a further method step S2b, the classifications obtained from the at least two models can each be allocated a confidence, which indicates, for example, the probability with which the corresponding model has correctly classified the plant status.

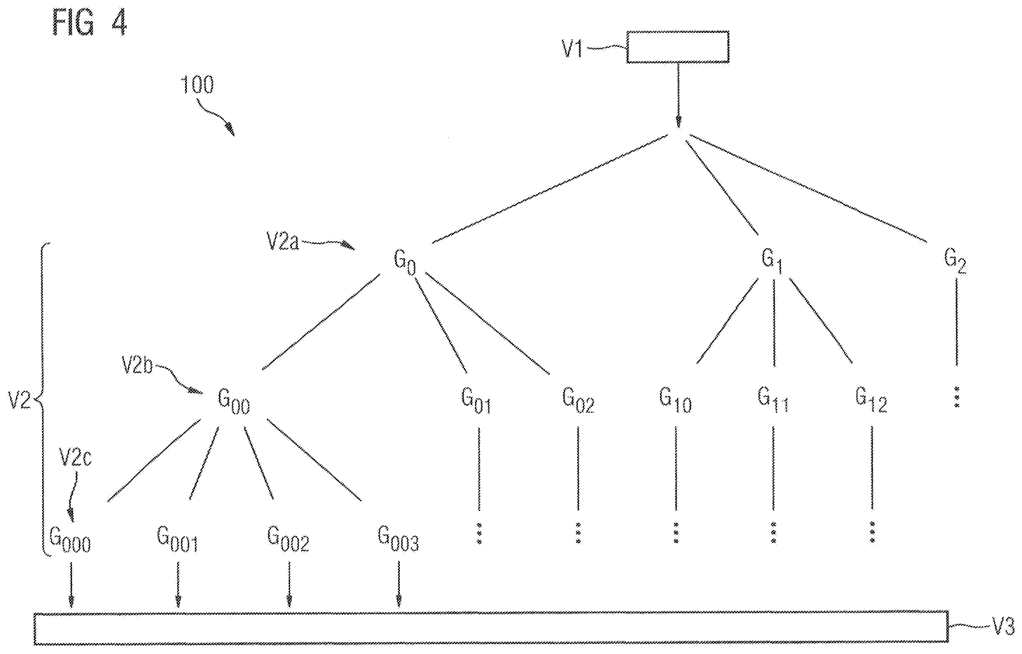

Preferably, the models classify the plant status in method step S2a in a specified sequence, such that a sequence of classifications results. Based on the resulting sequence, an overall classification can then be determined in a further method step S3, and this classifies the current plant status correctly with particularly high probability. In particular, a(n) (overall)confidence can be allocated to the overall classification or the resulting sequence which, for example, can be a measure of the probability that the plant status is correctly classified by the overall classification. The overall classification and/or the confidence allocated to it can be determined, for example, in training runs and/or on repeated execution of the diagnosis method 1 by way of a statistical evaluation of all sequences obtained during training runs and/or on repeated execution of the diagnosis method 1 (see FIG. 4).

Using the overall classification determined in method step S3 an evaluation can then be made to determine whether normal operation is present, in other words, the plant is running substantially fault-free.

If normal operation is present, in other words, then the plant is running substantially fault-free, in a further method step S7, corresponding diagnosis information can be output. Here, the diagnosis information preferably contains the overall classification as well as the confidence allocated to it. The diagnosis information can be output, for example, to a plant user or to a control system of the plant, which can continue to control the plant on the basis of this information.

If, on the other hand, a malfunction is present, i.e., the plant is running defectively or the plant status deviates from normal operation, then in a further method step S4 as check can be performed to determine whether the malfunction can be assessed by the plant user or a further monitoring system. For example, it can be checked whether a cause of the malfunction can be identified and/or which measures should be taken to avert the malfunction or transfer the plant back to normal operation again.

If this is not the case, then an extensive fault analysis can be peformed in a further method step S5, for example, to characterize the malfunction more accurately.

In a further method step S6, it is preferably checked whether the malfunction is already known. In particular, the check can be performed to determine whether the malfunction has already occurred. This can be performed in particular independently of the assessment of the malfunction in method step S4 and/or of the extensive fault analysis in method step S5.

In method step S7, corresponding diagnosis information is then preferably output. In the case of a malfunction, in addition to the overall classification and the confidence allocated to it the diagnosis information can also contain the information determined in method steps S4, S5 and/or S6.

In particular it is possible that a distinction is made between three cases based on the diagnosis information output in method step S7: (i) normal operation is present, (ii) a known malfunction is present and (iii) an unknown operation is present.

In a further method step S8, a data set, which is stored, for example, in a storage device of a control system, can be updated in particular based on the sequence of classifications determined in method step S2a. The data set can contain, for example, counter readings that indicate the frequency of the sequences that have occurred. Accordingly, preferably the counter reading, of the sequence determined in method step S2a, is increased. Preferably, the actual plant status determined, for example, by the plant user or the further monitoring system, i.e., the correct classification, is noted in the data set. The data set updated in this way can be used, as described in more detail in connection with FIG. 4, to increase the reliability of the allocation of overall classification to the sequence and the corresponding confidence, for example, by statistically evaluating the content of the data set.

In a further method step S9, an assessment can be made to determine whether the classification that has occurred via the models in method step S2a and the confidence allocation made in method step S2b is satisfactory. For example, a check can be performed to determine which models were incorrectly classified and/or whether a high confidence value was allocated to such incorrect classifications. If this is the case, an adjustment of the models or the confidences can be made in a further method step S10.

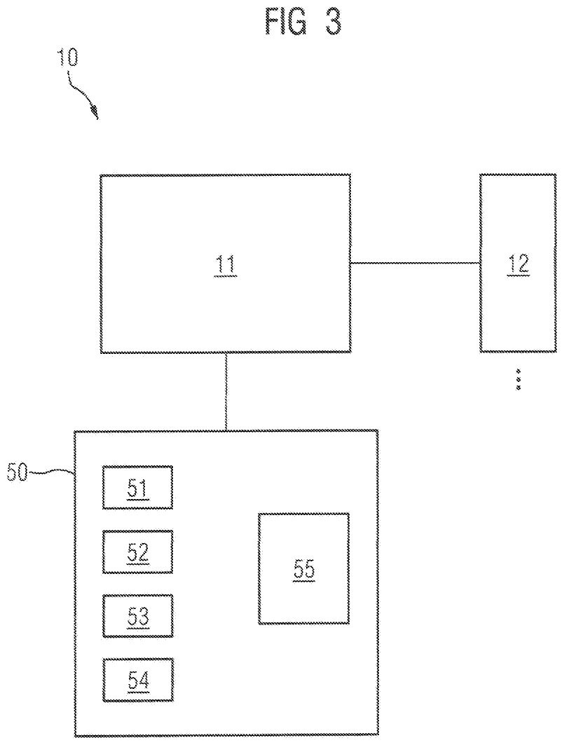

FIG. 3 shows an exemplary diagnosis system 50 for a process-engineering plant 10, where the diagnosis system 50 is configured to perform a diagnosis method, as described, for example, in connection with FIG. 2. The process-engineering plant 10 has a control system 11 and plant components 12, where the control system 11 and the plant components 12 are connected, for example, over a network. The plant components 12 can be formed, for example, as actuators and/or sensors to control or monitor a process of the plant 10.

The diagnosis system 50 preferably has a first module 51, a second module 52, a third module 53 and a fourth module 54 and a storage device 55. The first module 51 is preferably configured to provide a course over time of plant data, which at least partially characterizes the status of the plant. For this purpose, the first module 51 can be adapted in particular to access, during operation of the plant 10, measured variables provided by the plant components 12 and/or manipulated variables provided by the control system 11.

The second module 52 is preferably configured to classify the plant status with the aid of at least two models based on the provided course over time of the plant data. For this, the second module 52 can access, for example, the storage device 55 in which the at least two models are preferably stored. The models differ preferably with respect to a time window from which the plant data of the course over time forms the basis of the models. In other words, the models are adapted to process different time series of the plant data from the provided course over time.

The third module 53 is preferably configured to allocate one confidence respectively to the classifications resulting from the at least two models. The confidences can disclose, for example, a probability with which the classification determined by the second module 52 applies. The confidences can likewise be stored in the storage device 55.

The fourth module 54 is preferably configured to disclose diagnosis information based on the classifications of the plant status and the confidences allocated to them. The fourth module 54 can be formed for this purpose, for example, as an interface by which the diagnosis information can be output, for instance, to a plant user.

The first, second and third modules 51, 52, 53 can be formed in terms of hardware and/or software engineering. In particular, the first, second and third modules 51, 52, 53 can have a processing unit, preferably data- or signal-connected to a storage and/or bus system, in particular a digital processing unit, in particular microprocessor unit (CPU), or a module of such and/or one or more program(s) or program module(s). The CPU can be configured to execute commands, which are implemented as a program stored in a storage system, to detect input signals from a data bus and/or emit output signals to a data bus. A storage system can have one or more, in particular different, storage media, in particular optical, magnetic, solid state and/or other non-volatile media. The program can be of such a nature that it embodies or is capable of implementing the disclosed embodiments of the method in accordance with the invention, such that the CPU can execute the steps of such methods.

It is also conceivable that the plant data provided by the first module 51 is also stored in the storage device 55 in addition to the at least two models and the confidence. The first module 51 can be configured, in particular, to write the provided plant data substantially continuously, i.e., substantially in real time during operation of the plant 10, into a memory of the storage device 55. Consequently, the diagnosis system 50 can likewise perform the diagnosis method in real time.

FIG. 4 shows an exemplary training method 100 for a diagnosis system, as is shown, for example, in connection with FIG. 3. In a method step V1, at least two models are determined based on a first quantity of a plurality of courses over time of plant data by machine learning. The plant data of an individual course over time preferably at least partially characterizes the status of a process-engineering plant. Machine learning is based, moreover, on information with respect to plant statuses that correspond with precisely those plurality of courses over time. In other words, for the purpose of learning, information is provided about which plant status is actually characterized by the plant data of an individual course over time from the first quantity or which is the correct or true classification of the plant status.

Each individual course over time from the first quantity is preferably divided into at least two time segments, which correspond to different time windows, where it is possible for the time windows to also overlap. Each of the at least two time windows thereby define a time series. Based on a plurality of such time series from different courses over time, each defined by the same time window, and the information with respect to the corresponding plant statuses, one of the models respectively is then learned, such as by determining a pattern in these time series.

Preferably, the at least two learned models are applied in a further method step V2 to plant data from a second quantity of courses over time. The classifications can be performed with the aid of the models in a specified sequence. Different sequences of classifications can result in the process. The number of sequences that occur can be stored in a storage device, for instance in the form of a data set.

In a first sub-step V2a, for example the plant data from a first time window within the courses over time from the second quantity forms the basis of a first model. FIG. 4 illustrates, by way of example, a quantity Gᵥ for three possible classifications. The index v can assume, for example, the values 0, 1 or 2, with the quantity G₀ indicating, for instance, the number of classifications as normal operation N, the quantity G₁ the number of classifications as a first malfunction F1 and the quantity G₂ the number of classifications as a second malfunction F2.

In a second sub-step V2b, the plant data from a second time window within the courses over time from the second quantity can then form the basis of a second model. In the present example, it is assumed that the second model can again classify normal operation N, the first malfunction F1 or the second malfunction F2. By considering the classifications of the first model, quantities G_{vw} result for nine possible sequences, where the indices vw can again assume the values 0, 1 or 2, respectively. The quantity Goo therefore indicates, for example, the number of classifications as normal operation by two models, while the quantity G₁₂ indicates the number of classifications as the first malfunction F1 by the first model and as the second malfunction F2 by the second model.

In a further sub-step V2c, the sequences are also supplemented by information with respect to the plant status corresponding with the respective courses over time. The quantity G₀₀₂ represents, for example, the number of cases in which the first and second models have each classified normal operation N, while the underlying plant data from the course over time actually corresponds with the second malfunction F2.

Here, an additional quantity G₀₀₃ is also stated, which represents the case of unknown time series. If the considered time series corresponds with an unknown plant status, then it is added to the quantity G₀₀₃. What is not illustrated is the case where the models can also classify a time series as unknown. However, it is conceivable here to also allow further values for the indices vwx, such that, for example, a quantity G₃₀₃ can be formed.

In a further method step V3, the quantities G_{vwx} obtained in sub-step V2c are statistically evaluated to obtain a confidence for the different possible classifications by the at least two models.

For example, all quantities G_{vwx} in which the classification by the first model applies are added together and divided by the total of all courses over time from the first quantity. If, overall, for example, the sequence 000 is counted one hundred times, the sequence 011 twelve times and the sequence 001 three times, then this results in a probability of 100/115 that the classification by the first model applies.

The confidences for classifications by the second and optionally further models can also represent conditional confidences in which the classification that has already occurred or preceding classification is considered by at least one different model. If the first model classifies the plant status as normal operation N, for example, when determining the confidence for the classification by the second model, all quantities G_{vwx}, in which the classifications by the first and second models apply, can be added together and be divided by the total of all cases in which the classification by the first model applies.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A diagnosis method for a process-engineering plant, the method comprising:
providing a course over time of plant data, which at least partially characterizes a status of the process-engineering plant;
classifying the status of the process-engineering plant aided by a plurality of models based on the course over time of the plant data, the plurality of models differing with respect to a time window, from which the plant data are based;
allocating in each case one confidence to the classifications which result from the at plurality of models; and
outputting diagnosis information which is based on the classifications the status of the process-engineering plant and a confidence allocated thereto.

2. The diagnosis method as claimed in claim 1, wherein time windows differ with respect to their length of time.

3. The diagnosis method as claimed in claim 2, wherein each respective length of time of the time windows is logarithmically distributed with respect to each other.

4. The diagnosis method as claimed in claim 1, wherein time windows differ with respect to metrics.

5. The diagnosis method as claimed in claim 1, wherein at least one time window has logarithmic metrics.

6. The diagnosis method as claimed in claim 1, wherein the plant data is temporally, logarithmically spaced-apart as the course over time.

7. The diagnosis method as claimed in claim 1, wherein an input signal relating to the status of the process-engineering plant is detected and forms a basis for an adjustment of the confidences.

8. The diagnosis method as claimed in claim 1, wherein an input signal relating to the plant status is detected and forms a basis for an adjustment of at least one model of the plurality of models.

9. The diagnosis method as claimed in claim 1, wherein a status analysis of the status of the process-engineering plant is performed based on at least one classification.

10. The diagnosis method as claimed in claim 1, wherein the diagnosis information comprises an overall classification of the plant status; and wherein the overall classification is determined on the basis of the classifications, which result from the at least two models, and the confidences allocated thereto.

11. The diagnosis method as claimed in claim 10, wherein the overall classification is determined as a function of a sequence of classifications.

12. A diagnosis system for a process-engineering plant, comprising:
a processor;
memory; and
a storage device having a plurality of models, and confidences to be allocated to classifications stored therein;
wherein the processor is configured to:
provide a course over time of plant data, which at least partially characterizes a status of the process-engineering plant;
classify the status of the process-engineering plant aided by the plurality of models based on the course over time of the plant data, the plurality of models differing with respect to a time window, from which the plant data are based;
allocate, in each case, one confidence to the classifications which result from the at plurality of models; and
output diagnosis information which is based on the classifications the status of the process-engineering plant and a confidence allocated thereto.

13. A training method for a diagnosis system comprising a processor, memory, and a storage device having a plurality of models, and confidences to be allocated to classifications stored therein, the processor being configured to provide a course over time of plant data which at least partially characterizes a status of a process-engineering plant, classify the status of the process-engineering plant aided by the plurality of models based on the course over time of the plant data, the plurality of models differing with respect to a time window, from which the plant data are based, allocate, in each case, one confidence to the classifications which result from the at plurality of models, and output diagnosis information which is based on the classifications the status of the process-engineering plant and a confidence allocated thereto, the method comprising:
determining the plurality of models via machine learning;
wherein the plant data of a first quantity of a plurality of courses over time from at least two different time windows and information with respect to a plurality of process-engineering plant statuses corresponding to the plurality of courses over time form a basis for the machine learning.

14. The training method as claimed in claim 13, wherein
the confidences are determined based on a statistical evaluation of the classifications which result in accordance with the plurality of models for plant data from a second quantity of a plurality of courses over time.

15. The training method as claimed in claim 13, wherein a selection of the models is additionally stored in the storage device based on the classifications which result from the plurality of models for plant data from a second quantity of a plurality of courses over time.

16. The training method as claimed in claim 14, wherein a selection of the models is additionally stored in the storage device based on the classifications which result from the plurality of models for plant data from a second quantity of a plurality of courses over time.
